(19) United States
(12) Patent Application Publication
(10) Pub. No.: US 2006/0056881 A1
(43) Pub. Date: Mar. 16, 2006

(54) Developing roller

(75) Inventor: Young-min Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/213,953

(22) Filed: Aug. 30, 2005

(30) Foreign Application Priority Data
Sep. 13, 2004 (KR) 2004-72866

(51) Int. Cl. G03G 15/08

(52) U.S. Cl. 399/286

(57) ABSTRACT

A developing roller includes a central shaft and a body. The body of the roller contains a urethane modified polyester resin. The developing roller of an embodiment of the present invention features substantial durability, and stable toner chargeability, despite changes in the surroundings.

### CROSS-REFERENCE TO RELATED APPLICATIONS

This application claims benefit under 35 U.S.C. § 119 from Korean Patent Application No. 2004-72866, filed on Sep. 13, 2004, the disclosure of which is incorporated herein by reference.

### BACKGROUND OF THE INVENTION

1. Field of the Invention

The present invention relates in general to a developing roller. More specifically, the present invention relates to a developing roller for use in an electrophotographic developer featuring a stable chargeability of the toner particles, and superior durability of the roller without a problem of filming or wetted state on a photosensitive object.

2. Description of the Related Art

Electrophotographic devices include copiers, printers, fax machines, and combinations thereof. In recent years, a nonmagnetic one component toner developing mode has been the main mode used for those developing devices.

In general, a developing device in the nonmagnetic one component toner developing mode forms an electrostatic latent image on the surface of a photosensitive object (or photosensitive drum).

When a toner is supplied to a developing roller, a toner layer regulating unit (or simply a regulating unit) spreads toner particles evenly on the surface of the developing roller to form a thin toner layer. As the developing roller comes in contact with or close to the photosensitive drum having an electrostatic latent image borne on its surface, the toner adheres to the electrostatic latent image. By bringing the developing roller carrying a toner or nonmagnetic one-component developer in contact with the photosensitive drum bearing the electrostatic latent image, each toner particle has a chance to adhere to the latent image caused by frictional charge. Therefore, it is important that the developing roller has electrical conductivity.

A typical conductive roller for use in a developing device comprises a shaft at the center and a body having electrical conductivity. The body is usually made out of rubber or sponge. However, when the developing roller makes contact with the photosensitive drum, a vulcanizing agent in the rubber or residual low-molecular-weight rubber materials often contaminate the surface of the photosensitive drum. Also, the volume resistance of rubber is very susceptible to changes in its surroundings. Thus, rubber materials were not regarded as practical or suitable materials for the developing roller.

As an attempt to solve the above problems, a new technology was introduced in which the body of a developing roller was covered with two layers: an elastic layer formed of elastic materials and a coating layer on the top of the elastic layer. For instance, Japanese Patent Laid-Open No. H04-134468 discloses a coating layer comprising a resin dispersing electrical-conductivity additive. Examples of the resins dispersed include vinyl resin, epoxy resin, polyester resin, silicon resin, polyurethane resin, acryl urethane resin, and vinyl urethane resin. Still the invention imposes another problem. That is, although the amount of low-molecular-weight materials that oozed from the coating layer on the developing roller (this phenomenon is called “bleeding”) was considerably reduced, vinyl resin, epoxy resin, and polyester resin were too easily worn out and abraded, shortening the lifespan of the component.

In case of the developing roller applying silicon resin, the decreased frictional force between the developing roller and the toner outweighs the excellent abrasion resistance. The decreased frictional force results in the reduction in the amount of charges of the toner, and this leads to a background problem contaminating a non-image area, and toner scattering.

The developing roller applying polyurethane resin, on the other hand, shows effective abrasion resistance and sufficient frictional force against the toner. However, the developing roller is very susceptible to humidity changes, causing fluctuation of its electrical resistance. This property makes it difficult to obtain a stable image density.

Meanwhile, the developing roller applying acryl urethane resin, vinyl urethane resin, and modified resin of polyimide silicon resin (disclosed in Japanese Laid-Open Patent Publication No. 2003-091152) demonstrates sufficient frictional force against toner particles, and effective abrasion resistance and moisture resistance. However, there is insufficient adhesiveness between the coating layer and the elastic layer, resulting in deterioration of the durability of the roller.

### SUMMARY OF THE INVENTION

The present invention includes a developing roller comprising a designated polymer resin, which features a stable toner chargeability, effective durability, and stable electrical resistance independent of changes in the surroundings and provides a high quality image.

To achieve the above and/or other advantages, a developing roller comprises a central shaft and a body, wherein the body of the roller includes a urethane modified polyester resin.

The urethane modified polyester resin may be prepared by a reaction of polyester polyol resin and organic isocyanate.

Preferably, a weight average molecular weight (Mt) of the polyester polyol resin may be in a range from approximately 3000 to approximately 80000.

The polyester polyol resin may be prepared by a reaction of a dicarboxylic acid and a diol.

The dicarboxylic acid is selected from a group consisting of therephthalic acid, isophthalic acid, orthophthalic acid, diphenyl dicarboxylic acid, succinic acid, adipic acid, sebacic acid, fumaric acid, maleic acid, and itaconic acid.

The diol is selected from a group consisting of C₂-C₁₀ aliphatic glycols, C₆-C₁₂ cycloaliphatic glycols, and ethyl bond-containing glycols.

The organic isocyanate is selected from a group consisting of hexamethylene diisocyanate, tetramethylene diisocyanate, isophrone diisocyanate, 2,4-naphtylene diisocyanate, and 4,4-diisocyanate diphenylether.

The body of the roller comprises an elastic polymer material, carbon black, metal powder, and an ionic electrically-conductive agent.

The elastic polymer material may be selected from a group consisting of silicon rubber, acryl rubber, NBR, urethane rubber, EPDM, butyl rubber, epichlorohydrin rubber, chloroprene rubber, natural rubber, and a mixture thereof.

The body of the roller may comprise an elastic layer, and a surface layer covering a circumferential surface of the elastic layer.

The urethane polyester resin may be contained in the surface layer.

The specific volume electrical resistance of the body of the roller is in a range from approximately 1×10⁵ Ω•cm to approximately 1×10⁸ Ω•cm.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a conventional electrophotographic printer;

FIG. 2A is a schematic view of a developing roller according to an embodiment of the present invention;

FIG. 2B is a cross-sectional view of FIG. 2A;

FIG. 3A is a schematic view of a developing roller according to another embodiment of the present invention; and

FIG. 3B is a cross-sectional view of FIG. 3A.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

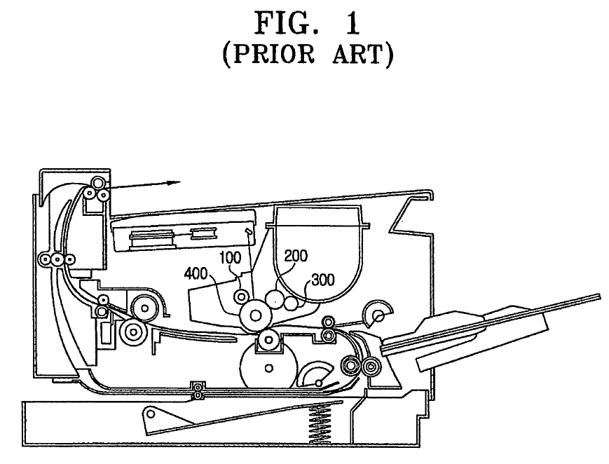

FIG. 1 is a schematic view of a laser printer to which a developing roller of the present invention is applied. Referring to FIG. 1, a charging roller 100 and a developing roller 200 are disposed in close contact with a photosensitive drum 400, and a supply roller 300 is disposed in close contact with the developing roller 200. The supply roller 300 supplies a toner from a toner cartridge to the developing roller 200, and the toner is transferred to the surface of the photosensitive drum 400 by the force of electrostatic attraction between the developing roller 200 and the photosensitive drum 400 so that an electrostatic latent image is formed on the photosensitive drum 400. At this time, the charging roller 100 charges the photosensitive drum 400 and generates the electrostatic force.

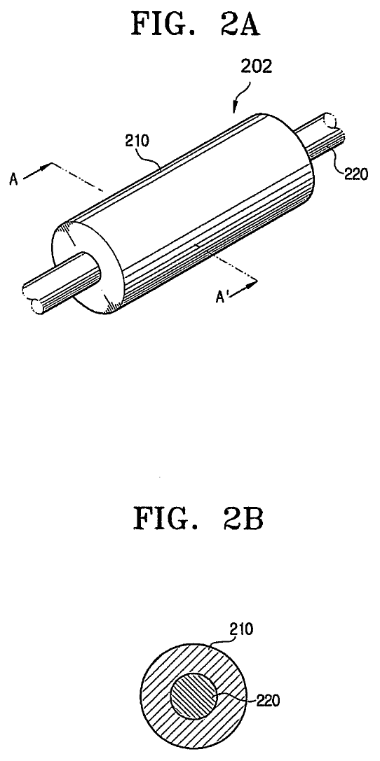

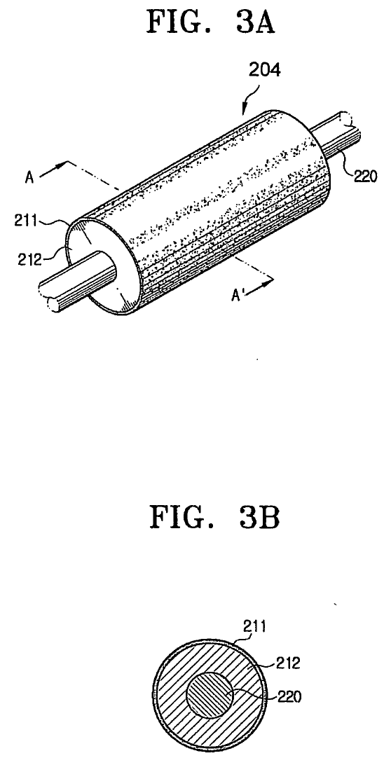

FIG. 2A and FIG. 2B, respectively, illustrate schematic and cross-sectional views of a developing roller 202 in accordance with an embodiment of the present invention, having a central shaft 220 covered with a body 210 that comprises elastic materials only. FIG. 3A and FIG. 3B, respectively, illustrate a schematic and a cross-sectional view of a developing roller 204 in accordance with another embodiment of the present invention, having a central shaft 220 that is covered with an elastic layer 212 made out of elastic materials and a surface layer 211 covering the circumferential surface of the elastic layer 212.

The developing roller according to an embodiment of the present invention has a structure including a central shaft made out of metals, and a roller body made of an elastic polymer material surrounding the shaft. Alternatively, the roller body may be covered with an elastic layer formed of an elastic polymer material, and a surface layer covering the circumferential surface of the elastic layer.

Specific examples of the elastic polymer material include silicon rubber, acryl rubber, NBR, urethane rubber, EPDM, butyl rubber, epichlorohydrin rubber, chloroprene rubber, and natural rubber. These polymers may be used alone or in combination, and are for illustrative purposes only.

In addition to the above elastic polymer material(s) as basic ingredients, the elastic layer may also contain other additives such as a foaming agent, a functional additive, a conductivity control agent and so forth, as long as these additives do not change the unique property of the elastic layer.

As mentioned above, the roller body may comprise only an elastic body, or double layers including an elastic layer formed of an elastic material, and a surface layer covering the circumferential surface of the elastic layer.

In particular the roller body of the developing roller according to an embodiment of the present invention includes urethane modified polyester resin. The urethane modified polyester resin may be included in the elastic body or the surface layer.

The urethane modified polyester resin for use in the developing roller of an embodiment of the present invention is prepared by a reaction of polyester polyol resin and organic isocyanate, and if necessary, chain extenders may be added for the reaction.

Preferably, a weight average molecular weight (Mt) of the polyester polyol resin for use in the preparation of urethane modified polyester resin is in a range from approximately 3000 to approximately 80000. If the weight average molecular weight (Mt) is approximately 3000 or less, the physical properties are impaired, and if the weight average molecular weight (Mt) is approximately 80000 or above, the resulting resin has a significantly high viscosity which makes it more difficult to manufacture a product therewith.

Polyester polyol resin is prepared by a reaction of a dicarboxylic acid and a diol. Examples of dicarboxylic acid include aromatic dicarboxylic acids such as therephthalic acid, isophthalic acid, orthophthalic acid, and diphenyl dicarboxylic acid; aliphatic dicarboxylic acids such as succinic acid, adipic acid, and sebacic acid; and dicarboxylic acids having a polymerizable unsaturated double bond, such as fumaric acid, maleic acid, and itaconic acid. These examples are for illustrative purposes only.

Examples of diol include C₂-C₁₀ aliphatic glycols such as ethylene glycol, 1,2-propylene glycol, 1,4-butane diol, 1,5-pentane diol, neopentyl glycol; C₆-C₁₂ cycloaliphatic glycols such as 1,4-cyclohexane dimethanol, tricyclo decane dimethylol; and ethyl bond-containing glycols such as diethylene glycol, triethylene glycol, and bisphenon A propylene addition. These examples are for illustrative purposes only.

Examples of the organic isocyanate compound for use in the preparation of urethane modified polyester resin include hexamethylene diisocyanate, tetramethylene diisocyanate, isophrone diisocyanate, 2,4-naphtylene diisocyanate, and 4,4-diisocyanate diphenylether. These examples are for illustrative purposes only.

Examples of the chain extender for use in the preparation of urethane modified polyester resin include glycols such as ethylene glycol and propylene glycol.

In effect, there is a variety of commercial products that may be used as the urethane modified polyester resin. Examples of such products include UR-1400, UR-2300, UR-3200, UR-3210, UR-4122, UR-5537, UR-8200, UR-8300, UR-8700, and UR-9500, each being manufactured by TOYO COTTON (Japan) COMPANY.

Preferably, the specific volume electrical resistance of the body of the developing roller in an embodiment of the present invention is in a range from approximately 1×10⁵ Ω•cm to approximately 1×10⁸ Ω•cm. If the specific volume electrical resistance is 1×10⁵ Ω• or less, current leaks occur from the surface of the roller, and if the specific volume electrical resistance is 1×10⁸ Ω•cm or above, the developability of the developing roller is impaired, which consequently causes toner filming.

To measure the specific volume electrical resistance of the roller, rollers were placed horizontally on a metal plate, and a 500 g load was added on both sides of the electrically conductive shaft of each roller, and 100 V (DC voltage) was applied between the shaft and the metal plate.

Requirements of the developing roller may be different depending on the physical properties of a toner being used. For example, the toner for use in an electrophotographic device which applies a developing roller according to an embodiment of the present invention is prepared by mixing a binder resin, a colorant, a charge control agent, a releasing agent, and other external additives.

Examples of the binder include polystyrene resin, styrene acryl co-polymer resin, polyester resin, epoxy resin, and rosin modified resin. These examples may be used alone or in combination, and are for illustrative purposes only.

Preferably, a number average molecular weight (Mn) of the binder is in a range from approximately 2500 to approximately 10000. If the number average molecular weight (Mn) is 2500 or less, problems related to heat resistance and storage stability occur, and if the number average molecular weight (Mn) is 10000 or above, a fixedness problem occurs. A glass transition temperature (T_{g}) of the binder is preferably in a range of approximately 55° C. to approximately 70° C., more preferably in a range of approximately 58° C. to approximately 67° C. If the T_{g} is approximately 55° C. or below, the toner is easily coagulated when stored, and if the T_{g} is approximately 70° C. or above, the toner fixability becomes lower. The fixing temperatures of electrophotographic devices currently available are not necessarily lower than 70° C.

Examples of the toner releasing agent include polyethylene wax, polypropylene wax, polyethylene oxide wax, polypropylene oxide wax, candelilla wax, rice-bran wax, MONTAN wax, FISCHER-TROPSCH wax, paraffin wax, carnauba wax, and ester wax. These examples may be used alone or in combination, and are for illustrative purposes only.

The content of the releasing agent is in a range from approximately 1 wt. % to approximately 7 wt. %, preferably approximately 2 wt. % to approximately 5 wt. % with respect to the total content of the binder. If the content of the releasing agent is approximately 1 wt. % or less, the releasing agent cannot function properly, so that an offset occurs on the fixing roller, causing problems in fixity. Meanwhile, if the content of the releasing agent is approximately 7 wt. % or above, dispersion of the releasing agent (i.e., a wax) in the binder or compatibility of the wax decreases, fluidity or charge property of the toner become weaker, and background and filming problems occur.

Examples of the colorant for use in the toner include carbon black and azo pigments. The content of the colorant in the toner is in a range from approximately 2 wt. % to approximately 15 wt. % with respect to the total content of the binder.

The content of the charge control agent for use in the toner is in a range from approximately 1 wt. % to approximately 7 wt. %, preferably approximately 2 wt. % to approximately 5 wt. % with respect to the total content of the binder.

Examples of the external additive for use in the toner include hydrophobic silica, hydrophobic titanium, hydrophobic aluminum oxide, zinc oxide, magnetite, strontium titanate, acryl resin particles, styrene resin particles, and nylon resin particles. These examples may be used alone or in combination, and are for illustrative purposes only. The content of the external additive in the toner is in a range from approximately 0.1 wt. % to approximately 3 wt. %, preferably approximately 2 wt. % to approximately 2.5 wt. %.

An average toner particle size is in a range from approximately 3.0 μm to approximately 12 μm, preferably from approximately 5.0 μm to approximately 10 μm. If the average toner particle size is approximately 3.0 μm or less, the cohesion of the toner particles increases, causing the filming problem on the roller. On the other hand, if the average toner particle size is approximately 12.0 μm or more, a printing image has a rough surface, resulting in deterioration of the image quality.

The following will now explain one embodiment of a developing roller with reference to FIGS. 3A and 3B.

FIG. 3A and FIG. 3B illustrate a developing roller comprising a shaft 200 and double layers, namely an elastic layer 212 and a surface layer 211, on the circumferential surface of the shaft 200.

The elastic layer has a JIS-A hardness of about 20 to about 80, preferably about 30 to about 70. JIS is an abbreviation of Japanese Industrial Standard. If the hardness of the elastic layer is 20 or below, an effective size precision is not obtained, and noise occurs in the image. Meanwhile, if the hardness of the elastic layer is 80 or above, the toner is under too much stress so that toner particles become smaller, and the roller has a filming problem.

Generally, the thickness of the surface layer on the developing roller is in a range from approximately 5 μm to approximately 70 μm, and more preferably approximately 10 μm to approximately 50 μm. If the thickness of the surface layer is approximately 5 μm or less, low molecular weight components of the elastic layer or additives may be permeated or penetrated into the surface layer, and if the thickness of the surface layer is approximately 70 μm or more, the roller hardens, and the toner is put under greater stress.

If necessary, the surface layer may include carbon black, and metal particles, and its specific volume electrical resistance may be adjusted within a range from approximately 1×10⁵ Ω•cm to approximately 1×10⁸ Ω•cm.

It is also possible to disperse 0.1 μm to 40 μm size particles on the surface layer of the developing roller to facilitate the transfer of the toner on the surface of the roller. Examples of such particles include organic resin particles such as PMMA (polymethyl methacrylate) particles, polystyrene particles, polyurethane particles, and nylon particles; and inorganic particles such as magnetite particles, ferrite particles, zinc oxide particles, titanium oxide particles, and aluminum oxide particles.

Generally, the surface roughness (Rz) of the developing roller, according to an embodiment of the present invention, is in a range from approximately 1 μm to approximately 30 μm, more preferably approximately 5 μm to approximately 20 μm. The surface roughness (Rz) of the developing roller is obtained by measuring the surface roughness at three different points on the developing roller by using the model 590A (manufactured by TOKYO PRECISION TOOLING, INC.), and averaging the three measurements.

The following will now explain, in detail, the preparation methods of the developing roller, and evaluation results thereof.

### EXAMPLES

### Toner Preparation Example 1

First, 250 g of fumaric acid, 115.5 g of succinic anhydride, and 1450 g of polyoxypropylene (2,2)-2,2-bis(4-hydroxyphenyl)propane were placed in a flask equipped with a thermometer, a stirrer and a flow system condenser, and a nitrogen gas was introduced into the flask through a nitrogen gas inlet pipe connected to the flask to create an inert atmosphere therein. The reaction was carried out at a temperature of 240° C. When the water produced from the reaction had almost disappeared, an AV value was measured, and was determined to be 2.4 KOHmg/g (JIS K0070).

122.5 g of trimellitic anhydride was added thereto, and the reaction was carried out for about 7 more hours. The reaction was pursued until the AV value approached 26 KOHmg/g. Thus, the desired polyester resin having 4200 of the Mn, 62.3° C. of the glass transition temperature and 124.3° C. of the softening point was prepared.

An 8 wt. % of carbon black (MOGUL-L, manufactured by KARBOT), 2 wt. % of a charge control agent (BONTORONS-34, manufactured by ORIENT CHEMICAL INDUSTRIES CO., LTD.) and 2 wt. % of a releasing agent (UMEX 110TS, manufactured by SANYL CHEMICAL INC.) were added to 100 wt. % of the prepared polyester resin.

The materials were mixed by the SUPER MIXER (manufactured by KAWATA INC.), kneaded by the twin extruder Model PCM-30 (manufactured by IKEKAI CO.), pulverized to fine particles by an IDS-2 type jet mill (manufactured by NIPPON PNEUMATIC MFG. CO.). The particles were then cut by a DS2-type dispersion separator (manufactured by NIPPON PNEUMATIC MFG. CO.) to obtain particles of 8.3 μm average particle size (diameter). Lastly, 0.3 wt. % of colloidal silica (R-974, manufactured by JAPAN AEROSIL CO.) and 0.5 wt. % of titanium (STT-30A, manufactured by TITAN MFG. CO.) were added to the particles and mixed by the SUPER MIXER to produce the desired toner A.

### Toner Preparation Example 2

First, 750 g of an ion-exchange material, 3.75 wt. % of sodium dodecyl benzene sulfonate as a dispersing agent and 5.0 wt. % of polyvinyl alcohol (PVA-625, manufactured by CURARE CO.) were placed in a flask equipped with a thermometer, a stirrer and a flow system condenser, and nitrogen gas was introduced into the flask through a nitrogen gas inlet pipe connected to the flask to create an inert atmosphere therein.

Next, 170 wt. % of styrene monomer, 20 wt. % of butyl methacrylate, 10 wt. % of butyl acrylate, 4 wt. % of a charge control agent (BONTORONS-89, manufactured by ORIENT CHEMICAL INDUSTRIES CO., LTD.), 10 wt. % of a releasing agent (WEC-5, manufactured by JAPAN YUJI CO.) and 5 wt. % of C.I.PIGMENT BLUE were mixed and stirred at 11000 rpm by means of TK HOMO-MIXER.

Polymerization initiators, that is 20 wt % of 2,2′-bis(4,4-di-tert-butyl valreronitrile) and 4 wt. % of 2.2′-bis(4,4,-di-tert-butylperoxy cyclohexyl propane), were then dissolved in the resulting mixture to produce a polymerizable monomer composition.

The above-prepared aqueous medium and the polymerizable monomer composition were pulverized under the nitrogen gas atmosphere at a temperature of 60° C. The reaction was allowed to continue for 2 hours at a temperature of 60° C. by a stirring motor equipped with stirring wings, and 8 more hours at a temperature of 80° C.

When the polymerization was completed, the particles were cooled, filtered, washed, and dried to obtain spherical polymerized particles of 6.2 μm average particle size (diameter). Lastly, 0.3 wt. % of colloidal silica (R-974, manufactured by JAPAN AEROSYL CO.) and 0.5 wt. % of aluminum oxide (RX-170, manufactured by JAPAN AEROSYL CO.) were added to the particles and mixed by the SUPER MIXER to produce the desired toner B having 6.2 μm average particle size (diameter).

### Example 1

An electroless nickel plated iron shaft in diameter of 8 mm and length of 228 mm was coated with an electrically conductive silicon rubber having the specific volume electrical resistance of 5.5×10⁵ Ω•cm and the JIS-A hardness of 50, and was ground to produce a silicon rubber roller with an outer diameter of 20 mm.

Meanwhile, 10 wt. % of an electrically conductive carbon black (VUCAN XC72R, manufactured by CABOT CO.,) and 7 wt. % of zinc oxide particles (VPSINC-5, manufactured by SAKAI CHEMICAL INDUSTRY CO., LTD.) were dispersed in the urethane modified polyester resin (UR-4122, manufactured by TOYO COTTON CO.). The resulting solid product was diluted to 13 wt. % with the methyl ethyl ketone/toluene solution (50:50) to produce a developing roller coating material I.

Thusly produced developing roller coating material I was sprayed over the above-prepared silicon rubber roller to a thickness of 15 μm, and the rubber roller was dried to produce a developing roller A.

### Example 2

A developing roller coating material II was prepared by using the same procedure described in Example 1, except that a mixture of 70 wt. % of UR-1400 (manufactured by TOYO COTTON CO.) and 30 wt. % of UR-2300 (manufactured by TOYO COTTON CO.) was used to replace the UR-4122, and then a developing roller B was produced.

### Example 3

An electroless nickel plated iron shaft having a diameter of 8 mm and length of 257.5 mm was coated with an electrically conductive NBR rubber having the specific volume electrical resistance of 6.8×10⁶ Ω•cm and the JIS-A hardness of 68, and was ground to produce an NBA rubber roller with an outer diameter of 16.03 mm.

Meanwhile, 10 wt. % of an electrically conductive carbon black (PRINTEX XE2, manufactured by DEGUSSA CO., LTD.) and 12 wt. % of magnetite particles (BL-500, manufactured by TITAN MFG. CO.) were dispersed in the urethane modified polyester resin (UR-1350, manufactured by TOYO COTTON CO.). The resulting solid product was diluted to 12 wt. % with the methyl ethyl ketone/toluene solution (50:50) to produce a developing roller coating material III.

Thusly produced developing roller coating material III was sprayed over the above-prepared silicon rubber roller to a thickness of 14 μm, and the rubber roller was dried to produce a developing roller C.

### Example 4

A developing roller coating material IV was prepared by using the same procedure described in Example 1, except that the shaft was coated with an electrically conductive silicon rubber having the specific volume electrical resistance of 4.3×10⁷ Ω•cm and the JIS-A hardness of 53°, and was ground to produce a silicon rubber roller (i.e., the developing roller D) with an outer diameter of 20 mm as developing roller D.

### Comparative Example 1

A developing roller coating material V was prepared by using the same procedure described in Example 1, except that a polyester resin (VYLON®200, manufactured by TOYO COTTON CO.) was diluted in an organic solvent of xylene/tetrahydrofuran (70:30) to 12 wt. %, and carbon black and zinc oxide were evenly dispersed therein as in Example 1. By spray coating the silicon roller with the developing roller coating material V, a developing roller E was then produced.

### Comparative Example 2

A developing roller coating material VI was prepared by using the same procedure described in Example 1, except that a urethane resin (UP-851, manufactured by TOKUSHIKI CO.) was diluted in an organic solvent of toluene/N, N-Dimethylformamide (70:30) to 11 wt. %, and carbon black and zinc oxide were evenly dispersed therein as in Example 1. By spray coating the silicon roller with the developing roller coating material VI, a developing roller F was then produced.

### Comparative Example 3

A developing roller G was produced by using the same procedure as described in Example 1, except that the shaft was coated with an electrically conductive silicon rubber having the specific volume electrical resistance of 7.3×10⁸ Ω•cm and the JIS-A hardness of 51, and was ground to produce a silicon rubber roller (i.e., the developing roller G) with an outer diameter of 20 mm.

### Comparative Example 4

A developing roller H was produced by using the same procedure described in Example 1, except that the shaft was coated with an electrically conductive silicon rubber having the specific volume electrical resistance of 5.8×10⁴ Ω•cm and the JIS-A hardness of 65°, and was ground to produce a silicon rubber roller (i.e., the developing roller H) with an outer diameter of 20 mm.

Table 1 below shows different physical properties of the developing rollers A through H in the Examples and the Comparative Examples.

TABLE 1

| | Roller A | Roller B | Roller C | Roller D | Roller E | Roller F | Roller G | Roller H |
|---|---|---|---|---|---|---|---|---|
| JIS-A | 50° | 50° | 68° | 53° | 50° | 50° | 51° | 65° |
| hardness | | | | | | | | |
| of rubber | | | | | | | | |
| Specific | 8.5 × 10⁵ | 8.2 × 10⁵ | 4.2 × 10⁵ | 2.3 × 10⁷ | 7.3 × 10⁵ | 5.1 × 10⁵ | 4.8 × 10⁸ | 3.3 × 10⁴ |
| volume | | | | | | | | |
| electrical | | | | | | | | |
| resistance | | | | | | | | |
| (Ω · cm) | | | | | | | | |

Evaluation and Result

Each of the developing rollers A through H was installed in a printer using either toner A or toner B, and the printing image durability was tested by evaluating an initial printing image (Table 2) and a printing image after 2000 sheets of paper were printed, respectively. In particular, two controlled test environments, such as a temperature 30° C. and a relative humidity of 85% (Table 3) and a temperature of 10° C. and a relative humidity of 15% (Table 4), were set to test the image durability in each case.

The image densities in each table were measured by using a MACBETH densitometer Model 1200. In practice, the image density should be at least 1.2 or higher.

In each table, background (BG), current leakage, and toner fixability on each roller were evaluated as “O” (superior), “Δ” (average) and “X” (inferior), respectively.

TABLE 2
Evaluation Result of Initial Image

| | Roller A | Roller B | Roller C | Roller D | Roller E | Roller F | Roller G | Roller H |
|---|---|---|---|---|---|---|---|---|
| | (Toner A) | (Toner A) | (Toner B) | (Toner A) | (Toner A) | (Toner B) | (Toner A) | (Toner A) |
| Image | 1.42 | 1.41 | 1.43 | 1.38 | 1.41 | 1.42 | 1.13 | 1.48 |
| density | | | | | | | | |
| BG | ◯ | ◯ | ◯ | ◯ | X | ◯ | ◯ | Δ |
| Current | ◯ | ◯ | ◯ | ◯ | ◯ | ◯ | ◯ | X |
| Leakage | | | | | | | | |

TABLE 3
Evaluation Result of Image Durability @ 30° C. and 85% relative humidity

| | | Roller A | Roller B | Roller C | Roller D | Roller E | Roller F | Roller G | Roller H |
|---|---|---|---|---|---|---|---|---|---|
| | | (Toner A) | (Toner A) | (Toner B) | (Toner A) | (Toner A) | (Toner B) | (Toner A) | (Toner A) |
| 1k | Image | 1.43 | 1.42 | 1.44 | 1.40 | 1.44 | 1.43 | 1.21 | — |
| | Density | | | | | | | | |
| | Toner | ◯ | ◯ | ◯ | ◯ | Δ | Δ | ◯ | — |
| | Fixability | | | | | | | | |
| | on Roller | | | | | | | | |
| | BG | ◯ | ◯ | ◯ | ◯ | X | X | Δ | — |
| 2k | Image | 1.44 | 1.43 | 1.44 | 1.41 | — | — | 1.21 | — |
| | Density | | | | | | | | |
| | Toner | ◯ | ◯ | ◯ | ◯ | — | — | ◯ | — |
| | Fixability | | | | | | | | |
| | on Roller | | | | | | | | |
| | BG | ◯ | ◯ | ◯ | ◯ | — | — | X | — |

TABLE 4
Evaluation Result of Image Durability @ 10° C. and 15% relative humidity

| | | Roller A | Roller B | Roller C | Roller D | Roller E | Roller F | Roller G | Roller H |
|---|---|---|---|---|---|---|---|---|---|
| | | (Toner A) | (Toner A) | (Toner B) | (Toner A) | (Toner A) | (Toner B) | (Toner A) | (Toner A) |
| 1k | Image | 1.41 | 1.40 | 1.42 | 1.37 | 1.40 | 1.41 | 1.16 | — |
| | Density | | | | | | | | |
| | Toner | ◯ | ◯ | ◯ | ◯ | — | X | Δ | — |
| | Fixability | | | | | | | | |
| | on Roller | | | | | | | | |
| | BG | ◯ | ◯ | ◯ | ◯ | X | Δ | ◯ | — |
| 2k | Image | 1.41 | 1.39 | 1.42 | 1.36 | — | — | 1.15 | — |
| | Density | | | | | | | | |
| | Toner | ◯ | ◯ | ◯ | ◯ | — | — | X | — |
| | Fixability | | | | | | | | |
| | on Roller | | | | | | | | |
| | BG | ◯ | ◯ | ◯ | ◯ | — | — | Δ | — |

As may be seen from the Tables, each of the developing rollers in Example 1 through 4 containing the urethane modified polyester resin of embodiments of the present invention had stable image density and effective toner fixability without the background problem. On the other hand, the developing rollers using the polyester resin or the urethane resin had the background problem and ineffective toner fixability problems.

In the case that a developing roller had a substantial specific volume electrical resistance (e.g., Comparative Example 3), the image density was decreased so that the developing roller was not practical to use. In addition, in the case that a developing roller had a reduced specific volume electrical resistance (e.g., Comparative Example 4), current leakage occurred on the surface of the roller, as seen in the Evaluation Result of Initial Image, so that the developing roller was not practical to use.

In conclusion, by using the urethane modified polyester resin for the manufacture of the developing roller, the toner chargeability becomes stable, durability of the roller is improved despite changes in the surroundings, and a high quality image may be provided.

The foregoing embodiment and/or advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art without departing from the principles and spirit of the invention, the scope of which is defined in the claims and their equivalents.

What is claimed is:

1. A developing roller, comprising:
a central shaft; and
a body, wherein the body of the roller includes a urethane modified polyester resin.

2. The developing roller according to claim 1, wherein the urethane modified polyester resin is prepared by a reaction of a polyester polyol resin and an organic isocyanate.

3. The developing roller according to claim 2, wherein a weight average molecular weight (Mt) of the polyester polyol resin is in a range from approximately 3000 to approximately 80000.

4. The developing roller according to claim 2, wherein the polyester polyol resin is prepared by a reaction of a dicarboxylic acid and a diol.

5. The developing roller according to claim 4, wherein the dicarboxylic acid is selected from a group consisting of therephthalic acid, isophthalic acid, orthophthalic acid, diphenyl dicarboxylic acid, succinic acid, adipic acid, sebacic acid, fumaric acid, maleic acid, and itaconic acid.

6. The developing roller according to claim 4, wherein the diol is selected from a group consisting of C₂-C₁₀ aliphatic glycols, C₆-C₁₂ cycloaliphatic glycols, and ethyl bond-containing glycols.

7. The developing roller according to claim 2, wherein the organic isocyanate is selected from a group consisting of hexamethylene diisocyanate, tetramethylene diisocyanate, isophrone diisocyanate, 2,4-naphtylene diisocyanate, and 4,4-diisocyanate diphenylether.

8. The developing roller according to claim 1, wherein the body of the roller comprises an elastic polymer material, carbon black, metal powder, and an ionic electrically-conductive agent.

9. The developing roller according to claim 8, wherein the elastic polymer material is selected from a group consisting of silicon rubber, acryl rubber, NBR, urethane rubber, EPDM, butyl rubber, epichlorohydrin rubber, chloroprene rubber, natural rubber, and a mixture thereof.

10. The developing roller according to claim 1, wherein the body of the roller is covered with an elastic layer and a surface layer covering a circumferential surface of the elastic layer.

11. The developing roller according to claim 10, wherein the urethane modified polyester resin is in the surface layer.

12. The developing roller according to claim 1, wherein specific volume electrical resistance of the body of the roller is in a range from approximately 1×10⁵ Ω•cm to approximately 1×10⁸ Ω•cm.

13. The developing roller according to claim 1, wherein the urethane modified polyester resin further includes at least one of: a foaming agent, a functional additive, or a conductivity control agent, wherein the elasticity of the urethane modified polyester resin is not significantly reduced.

14. The developing roller according to claim 2, wherein chain extenders are added to the polyester polyol resin and the organic isocyanate.

15. The developing roller according to claim 14, wherein the chain extender is selected from the group consisting of ethylene glycol and propylene glycol.

16. The developing roller according to claim 1, wherein the urethane modified polyester resin is selected from the group consisting of UR-1400, UR-2300, UR-3200, UR-3210, UR-4122, UR-5537, UR-8200, UR-8300, UR-8700, and UR-9500.

17. An electrophotographic device having a developing roller that includes
a central shaft; and
a body, wherein the body of the roller includes a urethane modified polyester resin,
wherein the electrophotographic device utilizes a toner comprising:
a binder resin having a number average molecular weight in a range from approximately 25000 to approximately 10000 and a glass transition temperature in a range of approximately 55° C. to approximately 70° C., a colorant, a charge control agent, a releasing agent and external additives.

18. The electrophotographic device according to claim 17, wherein the binder is selected from the group consisting of polystyrene resin, styrene acryl co-polymer resin, polyester resin, epoxy resin, and rosin modified resin; the colorant is selected from the group consisting of carbon black and azo pigments; a content of the charge control agent is in a range from approximately 1 wt. % to approximately 7 wt. % with respect to a total content of the binder; the releasing agent is selected from the group consisting of polyethylene wax, polypropylene wax, polyethylene oxide wax, polypropylene oxide wax, candelilla wax, rice-bran wax, MONTAN wax, FISCHER-TROPSCH wax, paraffin wax, carnauba wax, and ester wax and has a content in a range from approximately 1 wt. % to approximately 7 wt. % with respect to the total content of the binder; and the external additives are selected from the group consisting of hydrophobic silica, hydrophobic titanium, hydrophobic aluminum oxide, zinc oxide, magnetite, strontium titanate, acryl resin particles, styrene resin particles, and nylon resin particles.

19. The electrophotographic device according to claim 17, wherein an average toner particle size is in a range from approximately 3.0 μm to approximately 12 μm.
